(19) United States
(12) Patent Application Publication
(10) Pub. No.: US 2026/0303782 A1
(43) Pub. Date: Oct. 1, 2026

(54) A METHOD, AN APPARATUS AND A COMPUTER PROGRAM PRODUCT FOR VIDEO ENCODING AND VIDEO DECODING

(71) Applicant: Nokia Technologies Oy, Espoo (FI)

(72) Inventors: Saverio Blasi, London (GB); Jani Lainema, Tampere (FI)

(21) Appl. No.: 19/489,817

(22) PCT Filed: May 27, 2024
(86) PCT No.: PCT/FI2024/050274

§ 371 Date: Dec. 3, 2025

(30) Foreign Application Priority Data
Jun. 29, 2023 (FI) 20235755

(51) Int. Cl. H04N 19/105; H04N 19/132; H04N 19/136; H04N 19/176; H04N 19/593

(52) U.S. Cl. CPC H04N 19/105; H04N 19/132; H04N 19/136; H04N 19/176; H04N 19/593

(57) ABSTRACT

The embodiments relate to a method and technical equipment for implementing the method. The method comprises identifying one or more reference lines; means for extracting reference samples for a block by means of reference lines not being adjacent to the block; means for performing an intraprediction for the block by means of a Planar prediction process and the extracted reference samples, wherein the Planar prediction process comprises determining predicted samples according to a distance between a reference line and the block.

### TECHNICAL FIELD

The present solution generally relates to video encoding and video decoding.

### BACKGROUND

Video encoding is a process, where input video is transformed into a compressed format suited for storage or transmission. In video decoding, the opposite is performed, i.e., compressed video is uncompressed back into a viewable form. The encoding process comprises prediction, where pixel values of a certain picture area are predicted. Then a prediction error, i.e., difference between the predicted pixels and the original pixels is coded.

### SUMMARY

The embodiments discussed in the present description provides an improved prediction solution to be used in video encoding and decoding.

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for identifying one or more reference lines; means for extracting reference samples for a block by means of reference lines not being adjacent to the block; means for performing an intra-prediction for the block by means of a Planar prediction process and the extracted reference samples, wherein Planar prediction process comprises determining predicted samples according to a distance between a reference line and the block.

According to a second aspect, there is provided a method, comprising identifying one or more reference lines; extracting reference samples for a block from reference lines not being adjacent to the block; performing an intra-prediction for the block by means of a Planar prediction process and the extracted reference samples, wherein the Planar prediction process comprises determining predicted samples according to a distance between a reference line and the block.

According to a third aspect, there is provided an apparatus comprising at least one processor, memory including computer program code, the memory and the computer program code configured to, with the at least one processor, cause the apparatus to perform at least the following: identify one or more reference lines; extract reference samples for a block from reference lines not being adjacent to the block; perform an intra-prediction for the block by means of a Planar prediction process and the extracted reference samples, wherein the Planar prediction process comprises determining predicted samples according to a distance between a reference line and the block.

According to a fourth aspect, there is provided computer program product comprising computer program code configured to, when executed on at least one processor, cause an apparatus or a system to: identify one or more reference lines; extract reference samples for a block from reference lines not being adjacent to the block; perform an intra-prediction for the block by means of a Planar prediction process and the extracted reference samples, wherein the Planar prediction process comprises determining predicted samples according to a distance between a reference line and the block.

According to an embodiment, a reference line is identified by a Multiple Reference Line index.

According to an embodiment, the Planar prediction process comprises a horizontal and/or a vertical interpolation.

According to an embodiment, the horizontal and/or the vertical interpolation comprises defining an array of samples in dependence on the multiple reference line index.

According to an embodiment, the horizontal and/or the vertical interpolation comprises weighted averages depending on the distance of each sample from the reference line.

According to an embodiment, wherein the weighted averages comprise computing weights where one of the weights is equal to the distance of each sample from the reference line.

According to an embodiment, weighted average for the vertical interpolation includes performing one of the following: a division or a multiplication or a summation or a binary shift by sum of the height of the block and the Multiple Reference Line index.

According to an embodiment, weighted average for the horizontal interpolation includes performing one of the following: a division or a multiplication or a summation or a binary shift by sum of the width of the block and the Multiple Reference Line index.

According to an embodiment, the Planar prediction process is determined by means of a Template-matching Multiple Reference Line method.

According to an embodiment, the reference samples are extracted by defining a horizontal and/or vertical array of reference samples, whereupon the apparatus comprises means for forming an array of reconstructed samples by means of the location of the block and reference line.

According to an embodiment, the Planar prediction is formed by means of the horizontal and/or vertical array

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of an encoding process;

FIG. 2 shows an example of a decoding process;

FIG. 3 shows an example of Multiple Reference Line indices;

FIG. 4 shows an example of determining a vertical Planer prediction;

FIG. 5 shows an example of two-phase Planar interpolation operation;

FIG. 6 is a flowchart illustrating a method according to an embodiment; and

FIG. 7 shows an apparatus according to an embodiment.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure.

A video codec comprises an encoder that transforms the input video into a compressed representation suited for storage/transmission, and a decoder that can un-compress the compressed video representation back into a viewable form. An encoder may discard some information in the original video sequence in order to represent the video in a more compact form (i.e. at lower bitrate).

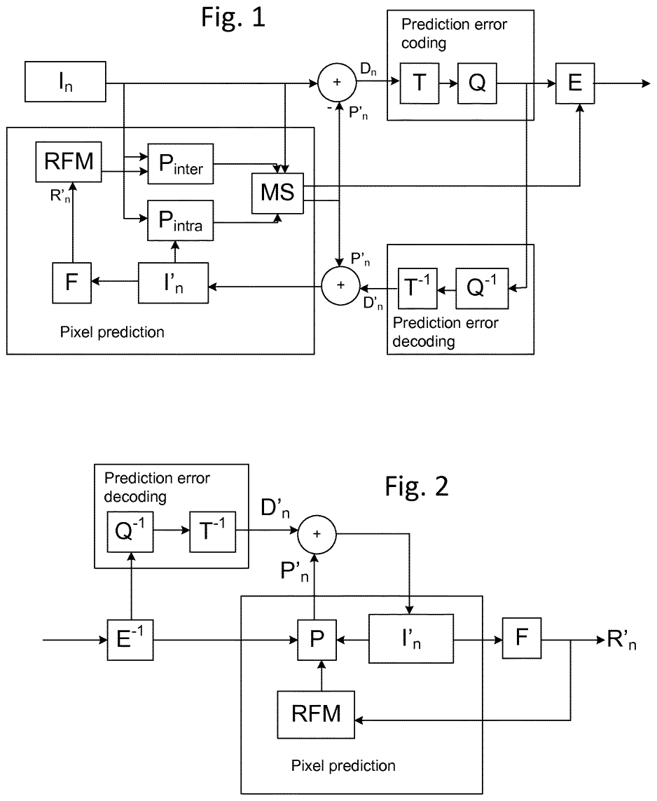

FIG. 1 shows an example of an encoding process for two-dimensional (2D) pictures, and FIG. 2 shows an example of a decoding process for 2D pictures. In FIG. 1, the following have been illustrated:
an image to be encoded (Iₙ);
a predicted representation of an image block (P′ₙ);
a prediction error signal (Dₙ);
a reconstructed prediction error signal (D′ₙ);
a preliminary reconstructed image (I′ₙ);
a final reconstructed image (R′ₙ);
a transform (T) and inverse transform (T⁻¹);
a quantization (Q) and inverse quantization (Q⁻¹);
entropy encoding (E);
a reference frame memory (RFM);
inter prediction (Pᵢₙₜₑᵣ);
intra prediction (Pᵢₙₜᵣₐ);
mode selection (MS), and
filtering (F).

In FIG. 2 the following have been illustrated:
a predicted representation of an image block (P′ₙ);
a reconstructed prediction error signal (D′ₙ);
a preliminary reconstructed image (I′ₙ);
a final reconstructed image (R′ₙ); an inverse transform (T-1);
an inverse quantization (Q⁻¹);
an entropy decoding (E-1);
a reference frame memory (RFM);
a prediction (either inter or intra) (P);
and filtering (F).

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture. The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

The Advanced Video Coding standard (which may be abbreviated AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated HEVC or H.265/HEVC) was developed by the Joint Collaborative Team—Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

Some key definitions, bitstream and coding structures, and concepts of H.264/AVC, HEVC, VVC, and/or AV1 and some of their extensions are described in this section as an example of a video encoder, decoder, encoding method, decoding method, and a bitstream structure, wherein the embodiments may be implemented. The aspects of various embodiments are not limited to H.264/AVC, HEVC, VVC, and/or AV1 or their extensions, but rather the description is given for one possible basis on top of which the present embodiments may be partly or fully realized.

Hybrid video codecs, for example ITU-T H.263, H.264/AVC, HEVC, and VVC, may encode the video information in two phases. At first, pixel values in a certain picture are (or “block”) are predicted for example by motion compensation means or by spatial means. In motion compensation based prediction an area in one of the previously coded frames that corresponds closely to the block being coded is found and used for prediction. In spatial prediction pixel values around the block to be coded are used. In the first phase, predictive coding may be applied, for example, as so-called sample prediction and/or so-called syntax prediction.

In the sample prediction, pixel or sample values in a certain picture area or “block” are predicted. These pixel or sample values can be predicted, for example, using one or more of motion compensation or intra prediction mechanisms.

Motion compensation mechanisms (which may also be referred to as inter prediction, temporal prediction or motion-compensated temporal prediction or motion-compensated prediction or MCP) involve finding and indicating an area in one of the previously encoded video frames that corresponds closely to the block being coded. Inter prediction may reduce temporal redundancy.

Intra prediction, where pixel or sample values can be predicted by spatial mechanisms, involve finding and indicating a spatial region relationship. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

In the syntax prediction, which may also be referred to as parameter prediction, syntax elements and/or syntax element values and/or variables derived from syntax elements are predicted from syntax elements (de)coded earlier and/or variables derived earlier. Non-limiting examples of syntax prediction are provided below.

In motion vector prediction, motion vectors e.g., for inter and/or inter-view prediction may be coded differentially with respect to a block-specific predicted motion vector. In many video codecs, the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or co-located blocks in temporal reference picture. Differential coding of motion vectors is typically disabled across slice boundaries.

The block partitioning, e.g., from a coding tree unit (CTU) to coding units (CUs) and down to prediction units (PUs), may be predicted.

In filter parameter prediction, the filtering parameters e.g., for sample adaptive offset may be predicted. Prediction approaches using image information from a previously coded image can also be called as inter prediction methods which may also be referred to as temporal prediction and motion compensation. Prediction approaches using image information within the same image can also be called as intra prediction methods.

In the second phase of encoding, the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate).

In some video codecs, such as H.265/HEVC, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size is typically named as LCU (largest coding unit) or CTU (coding tree unit) and the video picture is divided into non-overlapping CTUs. A CTU can be further split into a combination of smaller CUs, e.g. by recursively splitting the CTU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs). Similarly, each TU is associated with information describing the prediction error decoding process for the samples within the said TU (including e.g. DCT coefficient information). It is typically signaled at CU level whether prediction error coding is applied or not for each CU. In the case there is no prediction error residual associated with the CU, it can be considered there are no TUs for the said CU. The division of the image into CUs, and division of CUs into PUs and TUs is typically signaled in the bitstream allowing the decoder to reproduce the intended structure of these units.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

Instead, or in addition to approaches utilizing sample value prediction and transform coding for indicating the coded sample values, a color palette based coding can be used. Palette based coding refers to a family of approaches for which a palette, i.e., a set of colors and associated indexes, is defined and the value for each sample within a coding unit is expressed by indicating its index in the palette. Palette based coding can achieve good coding efficiency in coding units with a relatively small number of colors (such as image areas which are representing computer screen content, like text or simple graphics). In order to improve the coding efficiency of palette coding different kinds of palette index prediction approaches can be utilized, or the palette indexes can be run-length coded to be able to represent larger homogenous image areas efficiently. Also, in the case the CU contains sample values that are not recurring within the CU, escape coding can be utilized. Escape coded samples are transmitted without referring to any of the palette indexes. Instead their values are indicated individually for each escape coded sample.

In many video codecs, including H.264/AVC, HEVC, and VVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

Video codecs may support motion compensated prediction from one source image (uni-prediction) and two sources (bi-prediction). In the case of uni-prediction a single motion vector is applied whereas in the case of bi-prediction two motion vectors are signaled and the motion compensated predictions from two sources are averaged to create the final sample prediction. In the case of weighted prediction the relative weights of the two predictions can be adjusted, or a signaled offset can be added to the prediction signal.

In addition to applying motion compensation for inter picture prediction, similar approach can be applied to intra picture prediction. In this case the displacement vector indicates where from the same picture a block of samples can be copied to form a prediction of the block to be coded or decoded. This kind of intra block copying methods can improve the coding efficiency substantially in presence of repeating structures within the frame—such as text or other graphics.

In video codecs the prediction residual after motion compensation or intra prediction may be first transformed with a transform kernel (like DCT) and then coded. The reason for this is that often there still exists some correlation among the residual and transform can in many cases help reduce this correlation and provide more efficient coding.

Many video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Eq . 1 )$$

Where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

The phrase along the bitstream (e.g. indicating along the bitstream) may be defined to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream. For example, an indication along the bitstream may refer to metadata in a container file that encapsulates the bitstream.

Scalable video coding refers to coding structure where one bitstream can contain multiple representations of the content at different bitrates, resolutions or frame rates. In these cases, the receiver can extract the desired representation depending on its characteristics (e.g., resolution that matches best the display device). Alternatively, a server or a network element can extract the portions of the bitstream to be transmitted to the receiver depending on e.g., the network characteristics or processing capabilities of the receiver. A scalable bitstream may consist of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g., the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer pictures similarly to the decoded reference pictures of the enhancement layer. Consequently, the encoder may choose a base-layer reference picture as inter prediction reference and may indicate its use e.g., with a reference picture index in the coded bitstream. The decoder decodes from the bitstream, for example from a reference picture index, that a base-layer picture is used as an inter-prediction reference for the enhancement layer. When a decoded base-layer picture is used as a prediction reference for an enhancement layer, it is referred to as an inter-layer reference picture.

In addition to quality scalability following scalability modes exist:
Spatial scalability: Base layer pictures are coded at a lower resolution than enhancement layer pictures.
Bit-depth scalability: Base layer pictures are coded at lower bit-depth (e.g., 8 bits) than enhancement layer pictures (e.g., 10 or 12 bits).
Chroma format scalability: Enhancement layer pictures provide higher fidelity in chroma (e.g., coded in 4:4:4 chroma format) than base layer pictures (e.g., 4:2:0 format).

In all of the above scalability cases, base layer information could be used to code enhancement layer to minimize the additional bitrate overhead.

Scalability can be enabled in two basic ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame-based scalability, approach can be implemented very efficiently with minimal changes to single layer codecs while still achieving majority of the coding efficiency gains available. A reference frame-based scalability codec can be implemented by utilizing the same hardware or software implementation for all the layers, just taking care of the DPB management by external means.

There are number of intra-prediction modes available for existing video codecs. These intra-prediction modes comprises different directional intra-prediction modes, as well as prediction modes such as DC or Planar intra-prediction.

In Planar intra-prediction interpolation processes in both the vertical and horizontal directions are performed to obtain vertical and horizontal predictors, respectively. Then, sample-by-sample mean of these two predictors can be computed. Each interpolation process may be carried out by computing weighted averages of the reference samples. As an example, when computing the vertical predictor, each predicted sample at a given horizontal coordinate is obtained as the weighted average between the two reference samples at the same horizontal coordinate extracted from the top row and bottom row of the current block, respectively. Due to the fact the samples located on the bottom row of the current block are not reconstructed when predicting the current block, these are padded using the sample on the bottom-left of the current block. Similarly, the horizontal predictor is computed as the weighted average of the reference samples extracted from the columns on the left and right of the current block.

In coding solutions prior to present embodiments, the reference samples used in intra-prediction modes, such as Planar prediction, have been extracted from the immediate neighbourhood of the current block. For instance, the samples located on the row directly above the current block, and the column directly on the left of the current block may be used.

In some cases though, these reference samples may not be ideal, and other reference samples may be used instead. As an example, reference samples located on columns and/or rows further away from the current block may be used. However, when using these techniques that involve usage of reference samples located further away from the current block, the conventional Planar intra prediction process is not ideal, due to the fact that the resulting prediction block may inefficiently represent the content of the current block, as the spatial location of reference samples with respect to the current block is not taken into account.

The usage of intra-prediction reference lines located further away from the current block is well-known in video coding. The usage of these reference lines may be indicated by means of signalling. In WC, usage of these reference lines is indicated by means of a Multiple Reference Line (MRL) index, where MRL index 0 corresponds to using the conventional reference line formed of samples extracted directly above and on the left of the current block. Each increasing MRL index corresponds to using samples located further away from the current block in the vertical and horizontal direction. The MRL index is then signaled in the bitstream.

Recently, more advanced techniques have been proposed to better signal usage of MRL. An example of this is Template-based Multiple Reference Line (TMRL). TMRL consists in computing a list of possible combinations of intra-prediction modes and MRL indexes. The list is computed based on distortion costs obtained using a template, where the template is formed of the reference samples located at MRL index 0. An index is then signaled in the bitstream identifying the correct element in the TMRL list to use for the current block. The TMRL index replaces signalling of both the specific intra mode as well as the MRL index, thus improving the coding efficiency.

Now, by the present embodiments the known intra-prediction solutions are improved.

It is thus an aim to produce an intra-prediction for a block using reference samples extracted from reference lines that are not adjacent to the block by means of a Planar intra-prediction process, where the Planar intra-prediction process is performed in accordance to the distance of the reference samples from the current block. In particular, the Planar intra-prediction process is computed by performing interpolation processes in vertical direction and/or horizontal direction, where the predicted samples computed by the interpolation process are obtained depending on the distance of the reference line from the current block. As an example, each reference line may be identified by a Multiple Reference Line index. As an example, the Planar intra-prediction process is performed in accordance to the Multiple Reference Line index. As an example, the horizontal and/or vertical interpolation process needed to obtain the Planar intra-prediction are obtained in accordance to the Multiple Reference Line index.

According to an embodiment, the horizontal and/or vertical interpolation process may be performed to obtain the Planar intra-prediction. The horizontal and/or vertical interpolation comprises computing weighted averages that depend on the distance of each sample from the reference line. For example, in case of vertical interpolation, the weighted average includes performing a division by the sum of the height of the block and the Multiple Reference Line index. Similarly, in case of horizontal interpolation the weighted average includes performing a division by the sum of the width of the block and the Multiple Reference Line index.

In the previous embodiment, a division operation is used. However according to other embodiments, other operations can be used instead. Examples of other operations are multiplications, or summations, or binary shifts. For example, in case of vertical interpolation, the weighted average may include performing a multiplication by the sum of the height of the block and the Multiple Reference Line index. Similarly, in case of horizontal interpolation the weighted average may include performing a multiplication by the sum of the width of the block and the Multiple Reference Line index. As another example, division operations may be approximated by multiplications and binary shifts. A multiplier and a shift parameter for an approximated division operation can be determined different ways, for example using a combination of normalization (binary shifts based on the magnitude of the denominator) and table loop-up operations.

In the previous embodiments, the current intra-prediction may be identified by means of a Template-matching Multiple Reference Line method, where the Template-matching Multiple Reference Line method comprises computing a Planar intra-prediction process using reference samples extracted from reference lines that may not be adjacent to the block.

In that respect, an apparatus for encoding according to an embodiment comprises means for identifying one or more reference lines; means for extracting reference samples for a block from reference lines not being adjacent to the block; means for performing an intra-prediction for the block by means of a Planar prediction process and the reference samples, wherein Planar prediction process comprises determining predicted samples according to a distance between a reference line and the block.

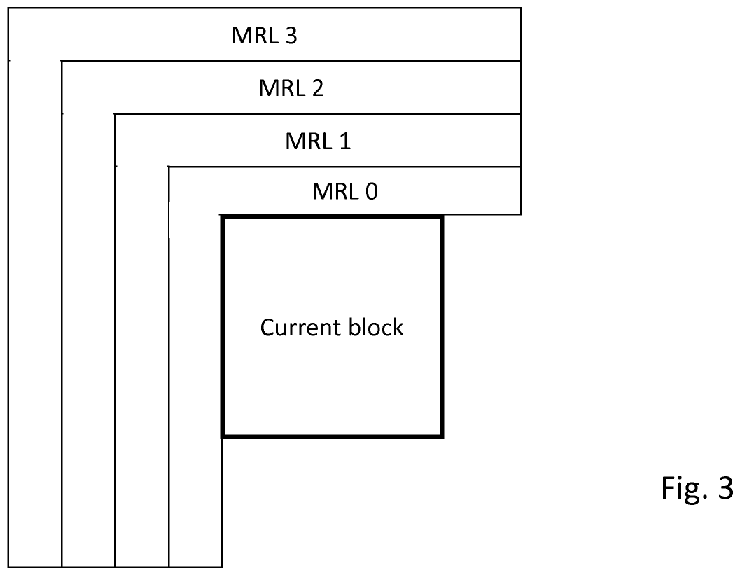

The Planar intra-prediction according to an embodiment for a block uses reference samples extracted from reference lines that may not be adjacent to the block. The Planar intra-prediction process is performed in accordance to the distance of the reference samples from the current block. As an example, each reference line is identified by a Multiple Reference Line (MRL) index, where increasing MRL indexes correspond to reference lines further away from the current block, as identified in FIG. 3. As an example, considering a current block and define the location of the current block within the frame as x_{curr} and y_{curr} which indicate the location of the top-left sample within the block. Then, as an example, reference samples used to form the Planar intra-prediction may include samples extracted from locations within the current block whose vertical coordinate y_{ref} is such that: y_{ref}<y_{curr}−1 and/or may include samples extracted from locations within the current block whose horizontal coordinate x_{ref} is such that: x_{ref}<x_{curr}−1.

According to an embodiment, the Planar intra-prediction process is computed by performing interpolation processes in the vertical and/or horizontal direction, where the predicted samples computed by the interpolation process are obtained in dependence to the distance of the reference line from the current block. As an example, each reference line may be identified by a Multiple Reference Line index. As an example, the Planar intra-prediction process may be performed in accordance to the Multiple Reference Line index. As an example, the horizontal and/or vertical interpolation process needed to obtain the Planar intra-prediction may be obtained in accordance to the Multiple Reference Line index.

As an example, the following is considered: a current block having a size W×H, and a MRL index m. It is also considered that a given set of reference samples is formed of already-reconstructed samples in the surrounding of the current block. Samples that are not already reconstructed may be replaced with other, already-reconstructed samples or computed by means of other padding techniques. The reference samples may be extracted by defining a horizontal and a vertical array of reference samples, where the horizontal array R_{H} is formed of reconstructed samples at locations:

$${R}_{H} ( i ) = ( {x}_{curr} - 1 - m + i , {y}_{curr} - 1 - m ) , i = 0 , 1 , 2 …$$

and the vertical array R_{V} is similarly formed of reconstructed samples at locations:

$${R}_{v} ( j ) = ( {x}_{curr} - 1 - m , {y}_{curr} - 1 - m + j ) , j = 0 , 1 , 2 …$$

According to an embodiment, the two arrays R_{H} and R_{V} may be filtered and or processed before they are used for prediction. As an example, padding operations may be used to fill the arrays.

The two arrays of reference samples may then be used to form a Planar prediction for the current block. According to an embodiment, a vertical Planar prediction may be computed as follows:
defining an array topRow in dependence on the MRL index m. As an example, topRow is defined as:

$$topRow ( k ) = {R}_{H} ( k + m ) , k = 0 , 1 , … , W - 1$$

defining a sample value bottomLeft in dependence on the MRL index m. As an example, bottomLeft is defined as:

$$bottomLeft = {R}_{V} ( H + m )$$

As another example, the bottomLeft can be defined as:

$$bottomLeft = {R}_{V} ( H + m + 1 )$$

computing a vertical Planar prediction Pᵥ(x,y) in dependence on the MRL index m. As an example, the vertical Planar prediction is computed in dependence on the vertical distance of a given pixel from the reference sample. In particular, the distance of a given pixel at a given vertical coordinate y may be defined as:

$${D}_{V} ( y ) = y - {y}_{curr} + m + 1$$

defining two weights as

$${W}_{BL} ( y ) = {D}_{V} ( y )$$

$${W}_{TR} ( y ) = H + m - {D}_{V} ( y )$$

determining the vertical Planar prediction as:

$${P}_{v} ( x , y ) = \frac{topRow ( x ) \times {W}_{TR} ( y ) + bottomLeft \times {W}_{BL} ( y )}{{W}_{BL} ( y ) + {W}_{TR} ( y )}$$

As another example, the distance of a given pixel at a given vertical coordinate y may be defined as:

$${D}_{V} ( y ) = y - {y}_{curr} + m$$

defining two weights as

$${W}_{BL} ( y ) = {D}_{V} ( y )$$

$${W}_{TR} ( y ) = H + m - {D}_{V} ( y )$$

determining the vertical Planar prediction as:

$${P}_{v} ( x , y ) = \frac{topRow ( x ) \times {W}_{TR} ( y ) + bottomLeft \times {W}_{BL} ( y )}{{W}_{BL} ( y ) + {W}_{TR} ( y )}$$

As another example, the distance of a given pixel at a given vertical coordinate y may be defined as:

$${D}_{V} ( y ) = y - {y}_{curr} + m + 1$$

defining two weights as

$${W}_{BL} ( y ) = {D}_{V} ( y )$$

$${W}_{TR} ( y ) = H + 1 + m - {D}_{V} ( y )$$

determining the vertical Planar prediction as:

$${P}_{v} ( x , y ) = \frac{topRow ( x ) \times {W}_{TR} ( y ) + bottomLeft \times {W}_{BL} ( y )}{{W}_{BL} ( y ) + {W}_{TR} ( y )}$$

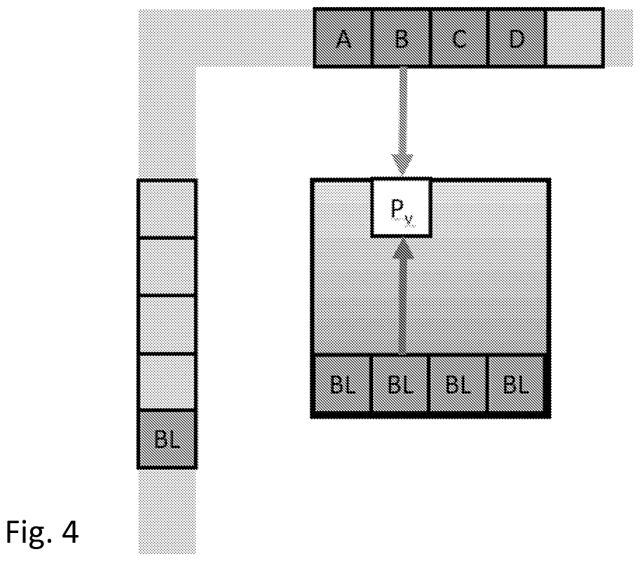

The process of computing a vertical Planar prediction is illustrated in FIG. 4.

Similarly, a horizontal Planar prediction may be computed as follows:
defining an array leftColumn in dependence on the MRL index m. As an example, leftColumn is defined as:

$$leftColumn ( k ) = {R}_{V} ( k + m ) , k = 0 , 1 , … , H - 1$$

defining a sample value rightTop in dependence on the MRL index m.

As an example, rightTop is defined as:

$$rightTop = {R}_{H} ( W + m )$$

As another example, the rightTop sample value can be defined as:

$$rightTop = {R}_{H} ( W + m + 1 )$$

determining a horizontal Planar prediction P_{H}(x,y) in dependence on the MRL index m. As an example, the horizontal Planar prediction is determined in dependence on the horizontal distance of a given pixel from the reference sample. In particular, the distance of a given pixel at a given horizontal coordinate x may be defined as:

$${D}_{H} ( x ) = x - {x}_{curr} + m + 1$$

defining two weights as

$${W}_{RT} ( x ) = {D}_{H} ( x )$$

$${W}_{LC} ( x ) = W + m - {D}_{H} ( x )$$

determining the horizontal Planar prediction as:

$${P}_{H} ( x , y ) = \frac{leftColumn ( y ) \times {W}_{LC} ( x ) + rightTop \times {W}_{RT} ( x )}{{W}_{RT} ( x ) + {W}_{LC} ( x )}$$

As another example, the distance of a given pixel at a given horizontal coordinate x may be defined as:

$${D}_{H} ( x ) = x - {x}_{c urr} + m$$

defining two weights as

$${W}_{RT} ( x ) = {D}_{H} ( x )$$

$${W}_{LC} ( x ) = W + m - {D}_{H} ( x )$$

determining the horizontal Planar prediction as:

$${P}_{H} ( x , y ) = \frac{leftColumn ( y ) \times {W}_{LC} ( x ) + rightTop \times {W}_{RT} ( x )}{{W}_{RT} ( x ) + {W}_{LC} ( x )}$$

In particular, the distance of a given pixel at a given horizontal coordinate x may be defined as:

$${D}_{H} ( x ) = x - {x}_{c urr} + m$$

defining two weights as

$${W}_{RT} ( x ) = {D}_{H} ( x )$$

$${W}_{LC} ( x ) = W + m - {D}_{H} ( x )$$

determining the horizontal Planar prediction as:

$${P}_{H} ( x , y ) = \frac{leftColumn ( y ) \times {W}_{LC} ( x ) + rightTop \times {W}_{RT} ( x )}{{W}_{RT} ( x ) + {W}_{LC} ( x )}$$

Determining the planar prediction as the average of the two predictors P_{H}(x,y) and Pᵥ(x,y):

$$P ( x , y ) = \frac{{P}_{H} ( x , y ) + {P}_{V} ( x , y )}{2}$$

The denominators needed to compute P_{H}(x,y) and P_{V}(x,y) may be equal to:

$${W}_{BL} ( y ) + {W}_{TR} ( y ) = H + m$$

$${W}_{RT} ( x ) + {W}_{LC} ( x ) = W + m$$

As another example, the denominators needed to compute P_{H}(x,y) and P_{V} (x,y) may be equal to:

$${W}_{BL} ( y ) + {W}_{TR} ( y ) = H + m + 1$$

$${W}_{RT} ( x ) + {W}_{LC} ( x ) = W + m + 1$$

According to an embodiment, in order to make the calculation of the horizontal and vertical Planar predictions more implementation-friendly, the division operations by (H+m) and (W+m) may be replaced by binary shifts, multiplications and summations.

According to an embodiment, the distances D_{H}(x) and D_{V}(y) may be computed as:

$${D}_{V} ( y ) = y - {y}_{curr}$$

$${D}_{H} ( x ) = x - {x}_{curr}$$

which corresponds to:

$${W}_{BL} ( y ) + {W}_{TR} ( y ) = H$$

$${W}_{RT} ( x ) + {W}_{LC} ( x ) = W$$

which, in case H and W can be exactly expressed as powers of 2, corresponds to replacing the division operations with binary shifts.

As yet another example, the number of division operations or multiply-shift-add operations substituting division operations can be reduced by performing the prediction in two phases. In the first phase the samples of topRow and leftColumn are projected to the locations corresponding to Multiple Reference Line index 0. This can be done by using the vertical and horizontal planar prediction described above and determining temporary reference arrays topRowTemp and leftColumnTemp, for example, as follows:

$$topRowTemp ( x ) = {P}_{V} ( x , {y}_{curr} - 1 ) , where x = 0 … W - 1$$

$$leftColumnTemp ( y ) = {P}_{h} ( {x}_{curr} - 1 , y ) , where y = 0 … H - 1$$

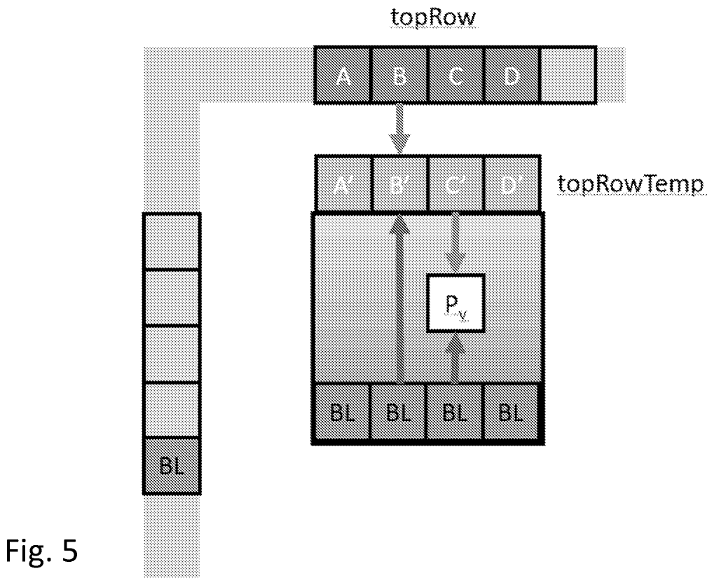

In the second phase, the topRowTemp and leftColumnTemp arrays instead of topRow and leftColumn can be used to determine the final planar prediction. In this case, if the width Wand the height H of the prediction block are powers of two also the denominators of the planar equations become powers of two and the divisions can be advantageously substituted with bitwise shift operations leading in to complexity reductions in typical implementation environments. FIG. 5 illustrates the two phase planar interpolation operation.

The Planar prediction process illustrated here can also be used to compute a prediction of a template region of already-reconstructed samples in the surrounding of the current block. As an example, a method operating according to the invention produces an intra-prediction for a given block, where the current intra-prediction mode to be used may be identified by means of a Template-matching Multiple Reference Line method, where the Template-matching Multiple Reference Line method comprises computing a Planar intra-prediction process using reference samples extracted from reference lines that may not be adjacent to the block. In particular, assuming an L-shaped template region in the surrounding of the current block formed of T reference lines, then reference samples can be extracted at a Multiple Reference Line index m=T, following the process described above.

The Planar prediction process illustrated here can also be used to determine the optimal intra-prediction mode to use on a given block by means of Template-based Intra Mode Derivation (TIMD). As an example, a method operating according to the invention produces an intra-prediction for a given block, where the current intra-prediction mode to be used may be identified by means of TIMD, where TIMD process comprises computing a Planar intra-prediction process using reference samples extracted from reference lines that may not be adjacent to the block, where the MRL index m may depend on the size of the TIMD templates.

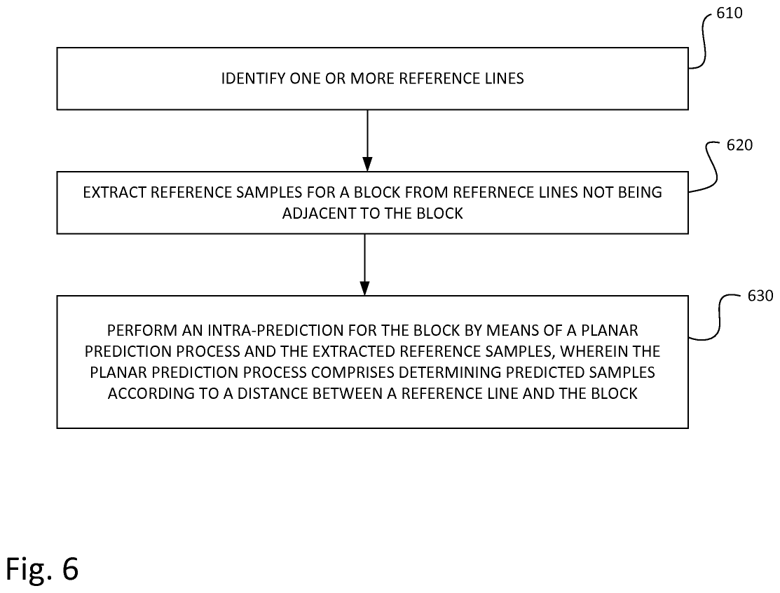

The method according to an embodiment is shown in FIG. 6. The method generally comprises identifying 610 one or more reference lines; extracting 620 reference samples for a block from reference lines not being adjacent to the block; performing 630 an intra-prediction for the block by means of a Planar prediction process and the extracted reference samples, wherein Planar prediction process comprises determining predicted samples according to a distance between a reference line and the block. Each of the steps can be implemented by a respective module of a computer system.

An apparatus according to an embodiment comprises means for identifying one or more reference lines; means for extracting reference samples for a block from reference lines not being adjacent to the block; means for performing an intra-prediction for the block by means of a Planar prediction process and the extracted reference samples, wherein Planar prediction process comprises determining predicted samples according to a distance between a reference line and the block. The means comprises at least one processor, and a memory including a computer program code, wherein the processor may further comprise processor circuitry. The memory and the computer program code are configured to, with the at least one processor, cause the apparatus to perform the method of FIG. 6 according to various embodiments.

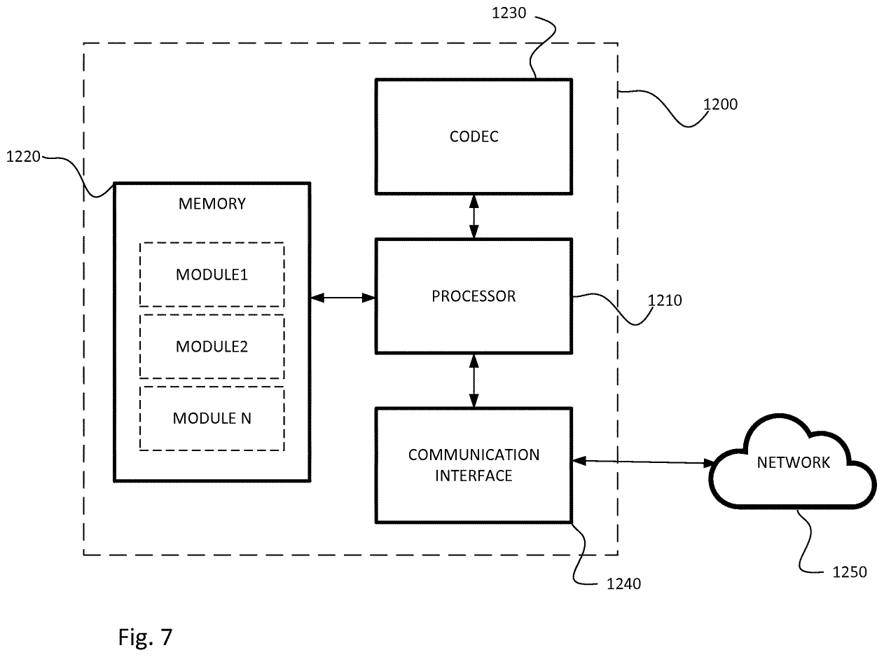

FIG. 7 illustrates an example of an electronic apparatus 1200, being an example of video coding system. In some embodiments, the apparatus may be a mobile terminal or a user equipment of a wireless communication system or a camera device. The apparatus 1200 may also be comprised at a local or a remote server or a graphic processing unit of a computer. The apparatus may also be comprised as part of a head-mounted display device

The apparatus 1200 comprises one or more processors 1210 and a memory 1220, wherein the memory 1220 stores computer instructions, for example in respective modules (Module1, Module2, ModuleN). The memory may store data in the form of image, video and/or audio data, and/or may also store instructions to be executed by the processors or the processor circuitry. The apparatus also comprises a codec 1230 that is configured to implement various embodiments relating to present solution. According to some embodiments, the apparatus may comprise an encoder or a decoder. The apparatus 1200 also comprises a communication interface 1240 which is suitable for generating wireless communication signals for example for communication with a cellular communications network, a wireless communications system, or a wireless local area network, and thus enabling data transfer over data transfer network 1250

The apparatus 1200 may comprise a display in the form of a liquid crystal display. In other embodiments of the invention the display may be any suitable display technology suitable to display an image or video. The apparatus 1200 may further comprise a keypad. In other embodiments of the invention any suitable data or user interface mechanism may be employed. For example, the user interface may be implemented as a virtual keyboard or data entry system as part of a touch-sensitive display. The apparatus 1200 may comprise a microphone or any suitable audio input which may be a digital or analogue signal input. The apparatus 1200 may further comprise an audio output device which in embodiments of the invention may be any one of: an earpiece, speaker, or an analogue audio or digital audio output connection. The apparatus 1200 may also comprise a battery (or in other embodiments of the invention the device may be powered by any suitable mobile energy device such as solar cell, fuel cell or clockwork generator). The apparatus may further comprise a camera capable of recording or capturing images and/or video. The camera may be a multi-lens camera system having at least two camera sensors. The camera is capable of recording or detecting individual frames which are then passed to the codec 1230 or to processor 1210. The apparatus may receive the video and/or image data for processing from another device prior to transmission and/or storage.

The apparatus 1200 may further comprise e.g., the other functional units disclosed in any of the FIGS. 1-2 for implementing any of the present embodiments.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-13. (canceled)

14. An apparatus for encoding, comprising at least one processor, memory including computer program code, the memory and the computer program code configured to, with the at least one processor, cause the apparatus to perform at least the following:
identifying one or more reference lines;
extracting reference samples for a block based on reference lines not being adjacent to the block; and
performing an intra-prediction for the block by using of a planar prediction process and the extracted reference samples, wherein the planar prediction process comprises:
determining predicted samples according to a distance between a reference line and the block.

15. The apparatus according to claim 14, wherein the reference line is identified by a multiple reference line index.

16. The apparatus according to claim 15, wherein the planar prediction process comprises a horizontal and/or a vertical interpolation.

17. The apparatus according to claim 16, wherein the apparatus upon execution further caused to perform: defining an array of samples in dependence on the multiple reference line index to be used in the horizontal and/or the vertical interpolation.

18. The apparatus according to claim 16, wherein the horizontal and/or the vertical interpolation comprises weighted averages depending on a distance of each sample from the reference line.

19. The apparatus according to claim 18, wherein the apparatus upon execution further caused to perform: computing weights for the weighted averages, wherein one of the weights is equal to the distance of each sample from the reference line.

20. The apparatus according to claim 18, wherein the apparatus upon execution further caused to perform one of the following for the weighted averages for the vertical interpolation: a division or a multiplication or a summation or a binary shift by sum of a height of the block; and the multiple reference line index.

21. The apparatus according to claim 18, wherein the apparatus upon execution further caused to perform one of the following for the weighted averages for the horizontal interpolation: a division or a multiplication or a summation or a binary shift by sum of a width of the block; and the multiple reference line index.

22. The apparatus according to claim 14, wherein the apparatus upon execution further caused to perform: determining the planar prediction process by using a template-matching multiple reference line method.

23. The apparatus according to claim 14, wherein the reference samples are extracted by defining a horizontal and/or vertical array of reference samples, and wherein the apparatus upon execution further caused to perform: forming an array of reconstructed samples based on? of the location of the block and the reference line.

24. The apparatus according to claim 23, wherein the apparatus upon execution further caused to perform: forming a planar prediction by means of the horizontal and/or vertical array.

25. A method, comprising:
identifying one or more reference lines;
extracting reference samples for a block from reference lines not being adjacent to the block; and
performing an intra-prediction for the block using a planar prediction process and the extracted reference samples, wherein the planar prediction process comprises
determining predicted samples according to a distance between a reference line and the block.

26. The method according to claim 25, wherein the reference line is identified by a multiple reference line index.

27. The method according to claim 25, wherein the planar prediction process comprises a horizontal and/or a vertical interpolation.

28. The method according to claim 27 further comprising defining an array of samples in dependence on the multiple reference line index to be used in the horizontal and/or the vertical interpolation.

29. The method according to claim 27, wherein the horizontal and/or the vertical interpolation comprises weighted averages depending on a distance of each sample from the reference line.

30. The method according to claim 29, further comprising computing weights for the weighted averages, wherein one of the weights is equal to the distance of each sample from the reference line.

31. The method according to claim 29, further comprising performing one of the following for the weighted averages for the vertical interpolation: a division or a multiplication or a summation or a binary shift by sum of a height of the block and the multiple reference line index.

32. The method according to claim 29, further comprising one of the following for the weighted averages for the horizontal interpolation: a division or a multiplication or a summation or a binary shift by sum of a width of the block and the multiple reference line index.

33. The method according to claim 25, further comprising determining the Planar prediction process by means of a Template-matching Multiple Reference Line method.
